(19) United States
(12) Patent Application Publication
(10) Pub. No.: US 2018/0269573 A1
(43) Pub. Date: Sep. 20, 2018

(54) Hierarchical Phase Shift Apparatus for Array Antenna Weight Look Ahead, Elaboration, and Beam-splitting Methods

(71) Applicant: James Wang, San Marino, CA (US)

(72) Inventor: James Wang, San Marino, CA (US)

(21) Appl. No.: 15/984,864

(22) Filed: May 21, 2018

Related U.S. Application Data
(63) Continuation of application No. 14/479,352, filed on Sep. 7, 2014.

(51) Int. Cl. H01Q 3/26; G01S 3/14

(52) U.S. Cl. CPC H01Q 3/2605; G01S 3/14

(57) ABSTRACT

An array antenna system consists of layered construct of subarrays. Each beam pointing angle requires an antenna weight vector (AWV). A circuit tracks the changing orientation of a beam within a much larger virtual array of antenna weights. A row or column of a local RAM may be determined to be least likely to be read next and is overwritten with antenna weights more likely to be read next. An address translation circuit represents the RAM as a barrel. An adaptively adjusted antenna weight method optimizes received signal power. A beam splitting method provides a mirror beam pointing direction by wrapping around a look ahead table of antenna weight vectors when an antenna is itself gyrating or when a remote transceiver is anticipated to transit the horizon.

### CROSS-REFERENCES TO RELATED APPLICATIONS

The present invention is a continuation of application Ser. No. 14/479,352 Filed: Sep. 7, 2014 which is incorporated by reference and benefits from its priority.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### 1. Technical Field

As is known, a phased-array antenna allows a highly directive antenna beam to be steered toward a variable target direction in any mobile situation. The direction of the antenna beam is adjusted by resetting the phase shifts and amplitudes (antenna weight vector) of the antenna elements. The classification may be within radio wave antennas for point to point communications between mobile devices 343,

### 2. Description of the Related Art

A conventional phased-array antenna enables a highly directive antenna beam to be steered toward a certain direction. The direction of an antenna beam may be controlled by setting the phase shifts of each of the antenna elements. However, to enable higher mobility, the phase shifts must be updated more quickly than conventionally practiced. In addition, cost and space considerations eliminate any conventional deployment of parallel data buses. Thus, it can be appreciated that what is needed is a more efficient way of dissemination of the phase shift control information to a substantial number of phase shifters for an antenna array with a high number of antenna elements.

### BRIEF SUMMARY OF THE INVENTION

A phased-array or adaptive array antenna system consists of a layered construct of subarrays. Each subarray apparatus contains a plurality of antenna elements, each could consist of a plurality of passively combined antennas or a single antenna. Below that layer are both for a receive array, low noise amplifiers (LNA) and phase shifters and for a transmit array, phase shifters and power amplifiers (PA). An other layer has for a receive array, combiner, and for a transmit array, a splitter.

An efficient phase control apparatus for a phased-array antenna consisting of a number of small submodules (subarrays) is disclosed. Each submodule (subarray) has a digital interface and contains one or more antenna elements and associated phase shifters. The disclosed phase control apparatus includes channels for dissemination of minimum amount of phase control information to the submodules.

A serial bus is one channel provided to disseminate the phase shift control information. The serial bus has the advantages of simplicity and reduced volume, routing, and cost over a conventional parallel bus but at the disadvantage of lower bandwidth which would, if not overcome by the present invention, slow the dynamic response of the antenna beam. This is especially true for a phased-array antenna with high number of antenna elements. Minimizing the distribution of information enables a substantially lower bus speed and cost.

A plurality of steering control methods performed by a circuit or a processor performing instructions read from a non-transitory store are disclosed for each subarray: retrieving stored antenna weight vectors; adaptively adjusted weight setting; and anticipating wrap-around beam-splitting.

Type I Steering control: Consists of a set of codebook-based antenna weight vectors (AWVs), each vector corresponding to certain pointing angle in space. The codebook is pre-calculated and stored into non-transitory computer readable media external to the antenna array apparatus. The AWV could be calibrated to compensate for fixed or random bias and tolerances in the subarray. In general, a subarray consists of several elements clustered in an area of an overall array which has wider antenna beamwidth and small gain. Advantageously, dimension variations in a subarray is small due to its reduced dimension compared to the overall array. Additionally, wider beamwidth also reduces the sensitivity of the gain degradation due to any errors in the subarray. Type 1 steering control is based on a pre-determined pointing direction and its corresponding antenna weight vector (AWV). The method of pre-determined direction can be based on search the sky, localized search, dithering tracking, or other methods which can be the subjects of other disclosures.

A computer-readable random access memory (RAM) device contains a table of antenna weights, each of which may be accessed quickly for dynamic beam forming. A plurality of integrated circuits comprise memory devices and antenna beam control circuitry. The integrated circuits are connected by a serial bus to a much larger store of antenna weights suitable for directing the antenna beam orientation in azimuth and elevation. The memory devices on each integrated circuit only contains enough storage for a small field of view and must be re-loaded through a low bandwidth channel when relative target direction suggests a change in view.

An efficient method for requesting, receiving, and downloading externally stored antenna weights when necessary overwrites a row or a column in the RAM. The apparatus must anticipate when the beam direction will exceed the field of view of the presently stored antenna weights. A delay for loading antenna weights will result is a loss of signal and possibly loss of tracking due to movement of the antenna or of the target of the antenna beam.

A circuit tracks the changing orientation of the beam within a much larger virtual array of antenna weights to determine a delta azimuth or delta elevation and its rate of change. As the phase and amplitude of the signal arriving at each element of the array changes, the antenna control circuit can determine a new azimuth and elevation which will select another storage location for antenna weights. If the change is not substantial, the antenna weights in the nearby storage locations of the RAM device can be accessed rapidly.

If the rate of change for the angular beam direction exceeds a threshold, a row or column of the RAM may be determined to be least likely to be read next and is overwritten with antenna weights more likely to be read next. The array of antenna weights may be thought of a rectangular bullseye, which contains the antenna weight for current beam direction and antenna weights for the most likely beam directions and occupies a portion RAM. If the direction of the array is off center and impinges one of the outermost “rings”, additional antenna weights should be requested in anticipation of further movement in that direction. Or if two rings are rapidly transitted, stored antenna weights need to be recentered.

An address translation circuit represents the RAM as a barrel whose recently overwritten row or column effectively repositions the latest orientation of the beam toward the center of the antenna weight table. Data does not actually need to be shifted left, right, up, or down in the antenna weight RAM device because the address is virtual. A row of the RAM previously used to store antenna weights at the high edge of the array may be easily redefined to be at the low edge or vice versa. A column of the RAM previously used to store antenna weights at the inside edge of the array may be easily redefined to be at the outside edge. That is, each column may be considered part of a cylinder that wraps around the left and right.

Performed by a processor mathematically, the center location of the bulleye is represented and accessed by reading a pointer which a memory address stored into a computer readable media. The two rings are represented by the modulo value of the center +/− offset. This allows the center of the bulleye to be placed at any addressable location within the RAM device.

Type II Steering control: Consists of adaptively adjusted antenna weight setting without a pre-determined set of codebook. In the preferred embodiment, the adaptively adjusted antenna weight is based on optimizing the received signal power.

Type III Beam splitting antenna control: In a first condition when an antenna is itself gyrating with respect to a transceiver or in a second condition when one or multiple remote transceivers are anticipated to transit across the antenna's horizon, the steering control apparatus splits the beam to point in a mirror beam pointing direction by wrapping around the look ahead table. For example if the antenna is rolling, a transceiver which goes over the horizon in one direction may be anticipated to appear in a mirror direction. Or if two satellites are in low earth orbit, a second satellite can be anticipated to rise above the horizon as a first satellite sets below the horizon but in different quadrants of the sky.

The details of one or more embodiments of the invention are set forth in the accompanying drawings and the detailed disclosure below. Other features, objects, and advantages of the invention will be apparent from the description and drawings, and from the claims.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of a conventional processor used for performing method steps in an apparatus;

FIGS. 2-6 are block diagrams of elements of a system.

FIG. 7 is a flowchart of steps in a method performed by a processor;

FIG. 8 illustrates a corner of a LAT and the storage operations initiated when an optimum antenna direction approaches an annular boundary of the LAT;

FIG. 9 is a listing of pseudocode for access control over the Look Ahead Table;

FIG. 10 is a flowchart of a method; and

FIG. 11 illustrates the Look Ahead Table treated as a barrel store for overwriting a row of antenna weight vectors.

### DETAILED DISCLOSURE OF EMBODIMENTS OF THE INVENTION

All of the following transformations and logic operations are performed by an electronic circuit communicatively coupled to amplifiers, phase shifters, and electromagnetic antenna elements and processors adapted by executable instructions stored in non-transitory media. Applicant submits several non-limiting exemplary embodiments of the subject matter to facilitate apprehension of the invention as follows:

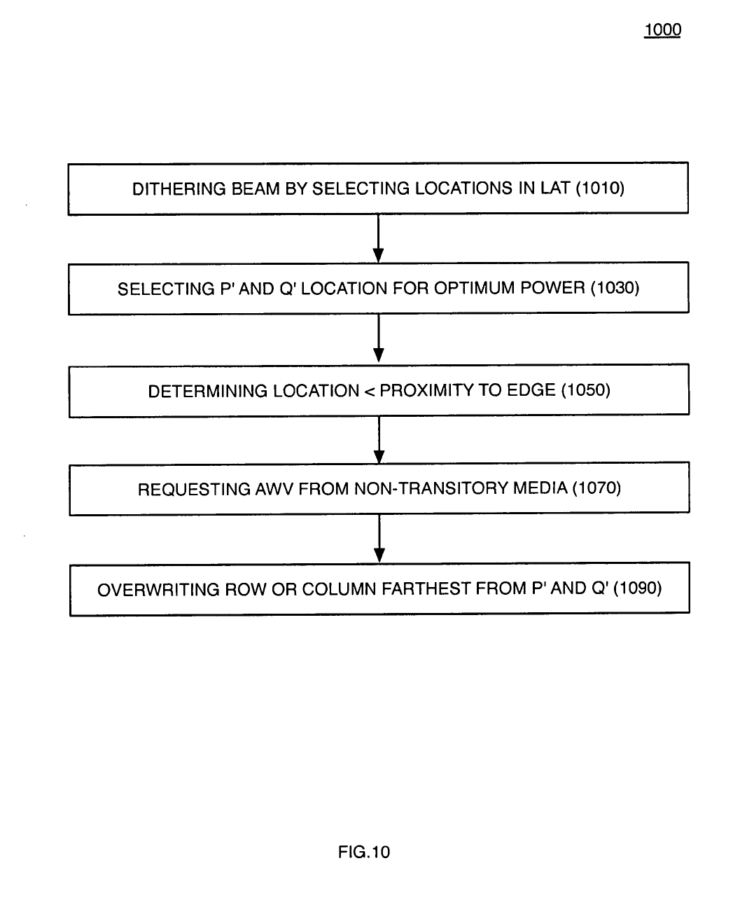

One exemplary aspect of the invention illustrated in FIG. 10 is a method 1000 of operation for an Antenna Weight Vector (AWV) Look Ahead Table (LAT) store access control circuit. This method includes: dithering an antenna beam among a plurality of directions by selecting locations in a Look Ahead Table (LAT) store of Antenna Weight Vectors (AWV) 1010; selecting the location (row p-prime and column q-prime) which provides optimum receive power for a remote transceiver 1030; determining that at least one of row p-prime and column q-prime are within a threshold of proximity to a nearest edge of the LAT 1050; requesting from non-transitory computer-readable media a plurality of AWVs which would be adjacent and exterior to the nearest edge of the LAT 1070; and overwriting at least one row or one column of the LAT farthest from row p-prime and column q-prime 1090; whereby the LAT is treated as a barrel store for row operations and a cylinder store for column operations and the LAT while being continuously updated by row or column overwrite operations effects a sphere of AWVs centered on row p-prime and column q-prime.

When a target transceiver requires beam movement diagonally toward a corner of the LAT, a row and a column of AWVs are needed to ensure that searching for improved received power can continue around any beam direction.

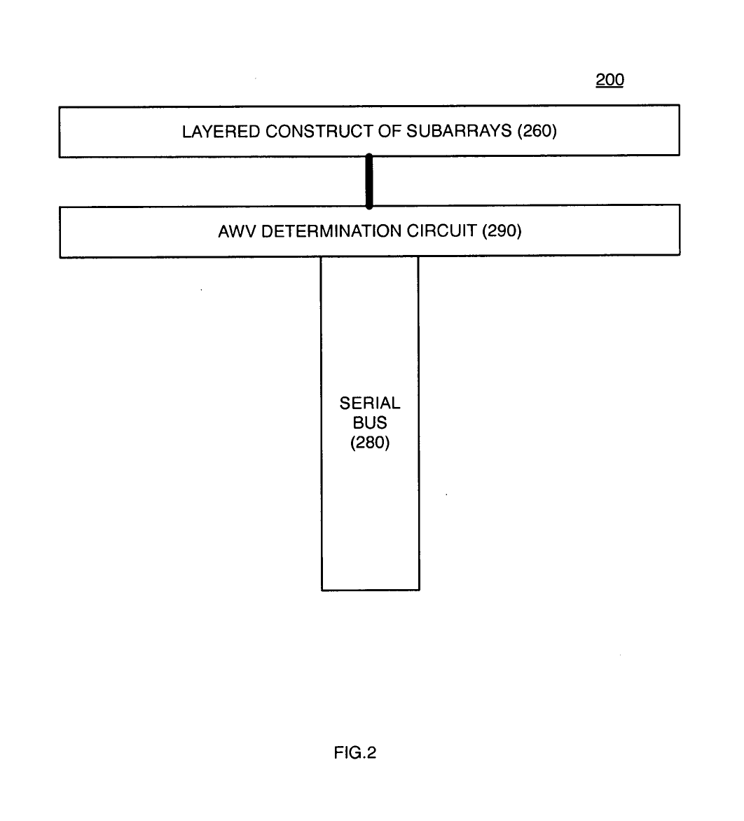

Another aspect of the invention illustrated in FIG. 2 is a layered phased-array antenna system 200. This system includes: at least one antenna weight vector (AWV) determination circuit 290; a serial bus to disseminate phase shift control information 280; and, a layered construct of sub-arrays 260.

Various approaches are disclosed to determine antenna weight vectors.

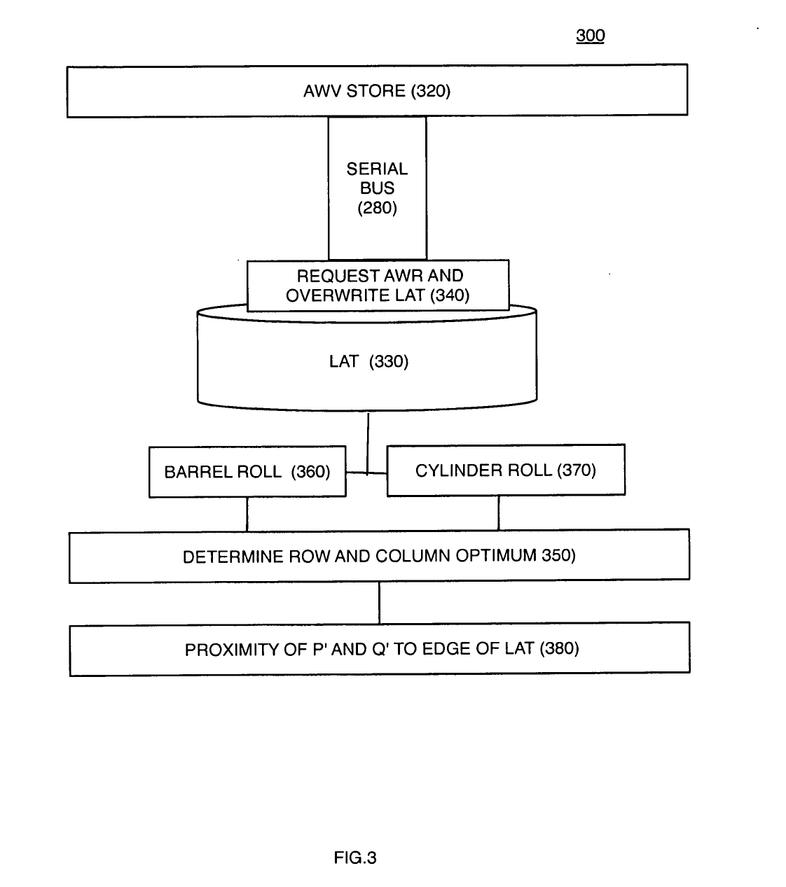

In an embodiment shown in FIG. 3, the at least one antenna weight vector (AWV) determination circuit 300 includes a Look Ahead Table (LAT) store access control circuit. The circuit includes a non-transitory computer-readable media encoded with AWV 320; coupled to the serial bus 280; and coupled to a random access store configured as rows and columns of a Look Ahead Table (LAT) 330, coupled to phase shifters and amplifiers of the layered construct of sub-arrays; a circuit to request a plurality of AWR and overwrite at least one of a row and a column of the random access store 340; a circuit to determine which row (p-prime) and column (q-prime) of AWV has the optimum receive power 350; a circuit to barrel roll row p-prime toward the center of the LAT by overwriting a row farthest from p-prime with a plurality of AWR read from the non-transitory computer-readable media 360; a circuit to cylinder roll column q-prime toward the center of the LAT by overwriting a column farthest from q-prime with a plurality of AWR read from the non-transitory computer-readable media 370; and a circuit to determine when to barrel roll or cylinder roll the LAT based on the proximity of p-prime and q-prime to the edge of the LAT 380.

This approach may be operated alone or in combination with an elaboration approach.

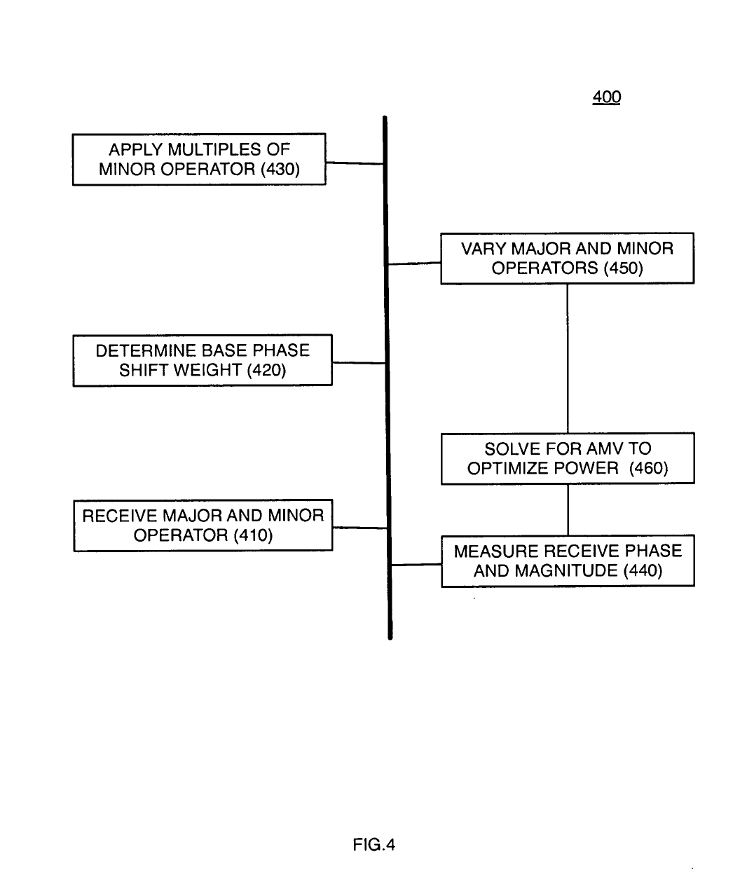

In an embodiment illustrated in FIG. 4, the at least one antenna weight vector (AWV) determination circuit is an AWV elaboration circuit 400. This circuit includes subcircuits: a circuit to receive a major operator and a minor operator 410; a circuit to determine a base phase shift weight 420; a circuit to apply one or more multiples of the minor operator 430; a circuit to measure the receive phase and magnitude 440; a circuit to vary the major operator and the minor operator 450; and a circuit to solve for an AWV which optimizes the receive power 460.

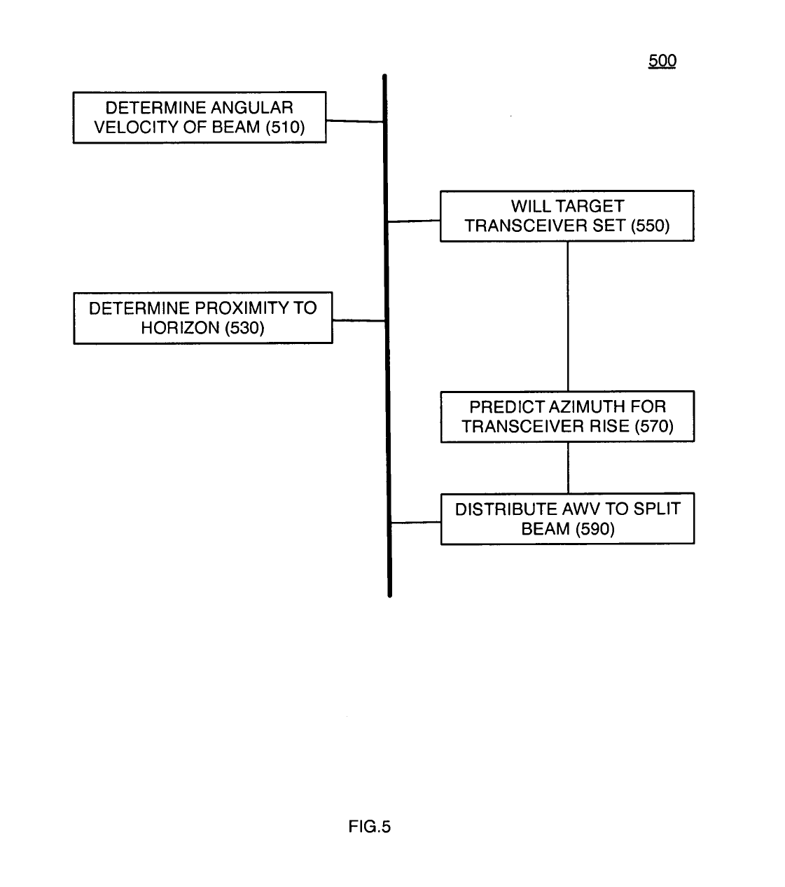

In another approach illustrated in FIG. 5, the handover between two cellular towers or two low earth orbit satellites may be anticipated with a plurality of directional beams independently aimed. Or if the phase-array antenna is itself gyrating, a single remote transceiver may set below the horizon in one direction and rise above the horizon in another expected direction.

In an embodiment, the at least one antenna weight vector (AWV) determination circuit is a wrap around beam-splitting circuit 500. This includes a circuit to determine angular velocity of the antenna beam 510; a circuit to determine proximity of the antenna beam to a horizon of the phased-array antenna 530; a circuit to determine a condition that a target transceiver will set below the horizon of the phased-array antenna based on antenna beam elevation and on the angular velocity exceeding a threshold 550; a circuit to determine a predicted azimuth for a target transceiver rise above the horizon of the phased-array antenna based on one of expected rollover and anticipated handover 570; and, a circuit to distribute AWV to a subset of the phased-array antenna system to provide beam-splitting 590.

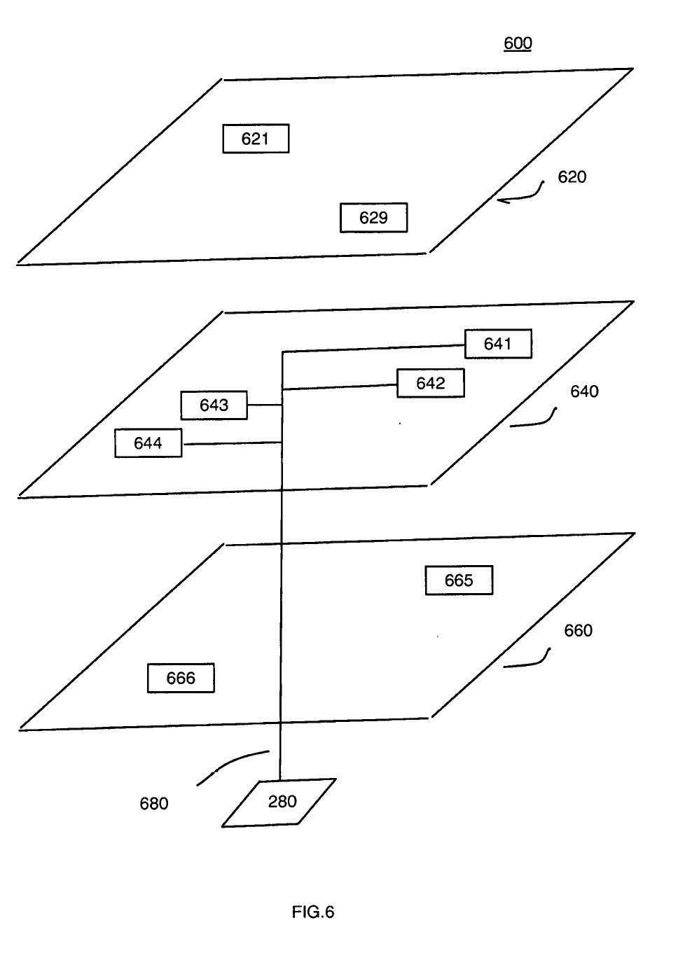

In an embodiment shown in FIG. 6, the layered construct of subarrays has in a first layer 620, a plurality of passively combined antenna elements 621-629; in a second layer 640, low noise amplifiers 641 and phase shifters 642 for reception, and phase shifters 643 and power amplifiers 644 for transmission; in a third layer 660, combiners 665 for reception, and splitters 666 for transmission, and interconnect 680 between the phase shifters and amplifiers to the at least one antenna weight vector (AWV) determination circuit 290.

As is known, many patentable circuits are equivalent to processors adapted by instructions stored in non-transitory media to control electronic devices for radio reception and transmission.

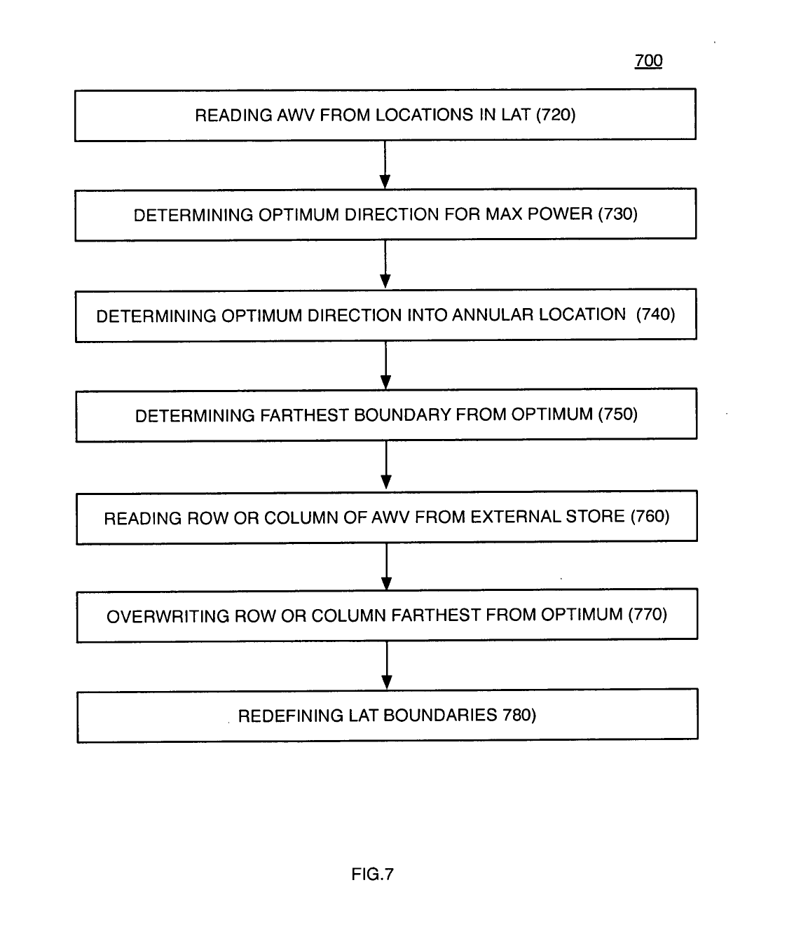

Another exemplary embodiment of the invention shown in FIG. 7 is a process for phased-array antenna beam direction control 700 which includes operation of a processor by executing instructions encoded on non-transitory media to perform: reading a plurality of antenna weight vectors (AWVs) from locations in a look ahead table (LAT) 720; determining from signal strengths and phases an optimum beam pointing direction for maximum receive power 730; determining that the optimum beam pointing direction has transited into a first annular location in the LAT 740; determining which at least one boundary of the LAT is farthest from the optimum beam pointing direction 750; reading at least one of a row of AWV and a column of AWV from external non-transitory store 760; overwriting at least one of a row of AWV and a column of AWR of the LAT farthest from the optimum beam pointing direction 770; and redefining the row boundaries and the column boundaries of the LAT 780 whereby the optimum beam pointing direction is shifted into an interior location relative to a set of annular locations of the LAT.

One aspect of the invention is an overall array apparatus which consists of a phased-array with subarrays as its antenna elements. For the receive array, each subarray output signal is passed through a phase shifter. The output of phase shifters for subarrays are then combined together to form the overall array output.

For a transmit array, the apparatus splits each input signal into multiple copies and each copy passes through a phase shifter before feeding into a transmit subarray.

In an embodiment, the apparatus performs a Type I Steering control method which applies a set of codebook-based antenna weight vectors (AWVs), each vector corresponding to certain pointing angle in space. The codebook is pre-calculated and stored. In embodiments, the vector is calibrated to compensate for fixed or random bias and tolerances of the subarray. Type I steering control provides a pre-determined antenna weight vector (AWV) for each pointing direction. The method of selecting among pre-determined directions can be based on search the sky, localized search, dithering tracking, or other methods.

In embodiments, this is performed by dithering the antenna beam in two directions separated by small increments. The antenna beam is steered toward the higher power direction. This dither will settle on the direction which yields equal power on two directions. Another way is to partition the array into two halves (left and right or upper and lower). The sum and difference signals of the two halves are produced and the antenna beam is steered toward the higher power direction until the difference is zeroed.

Conceptually, a series of antenna beam orientations within a Cartesian X,Y coordinate system may be described as strikes or balls in analogy to the home plate umpire's role in a baseball game because the antenna weights are more conveniently stored in rows and columns of a random access computer readable circuit device.

In further categorization, balls may be categorized as high, outside, low, and inside. In further categorization, balls may be high-inside, high-outside, low-inside, and low-outside.

Strikes are not further categorized and the strike zone may be defined as any middle range of the rows and columns of the RAM.

When a threshold number of balls are determined within a period of time as the antenna beam is being steered away from its previous direction, the apparatus sends a request for externally stored antenna weights in order to provide newer beam directions.

When antenna beam orientations are substantially within the strike zone, no externally stored antenna weights are requested.

When a ball is high or low, the RAM is treated as a barrel store, a row of antenna weights is overwritten with externally stored antenna weights and its virtual address becomes that of the row above or below the address of the ball.

When a ball is inside or outside the strike zone, the RAM is treated as cylinder store, a column of antenna weights is overwritten with externally stored antenna weights, and its virtual address becomes that of the column inside or outside of the ball.

In an embodiment, when a ball is high-inside, high-outside, low-inside, and low-outside, the apparatus sends a first request for a row and a second request for a column of externally stored antenna weights (or vice versa).

Whenever externally stored antenna weights are stored inside the apparatus, the virtual address circuit reconfigures the array of antenna weights so that the most recent ball if it is repeated will be categorized as a strike.

An exemplary embodiment illustrates the method:

Assuming that we have a 16.times.16 table of AWV (antenna weight vector) stored in our chip, each AWV represents a beam direction. The table covers a small small FOV (field of view). The initial beam direction corresponds to the AWV in the middle. As the antenna module moves, the beam pointing direction is updated by invoking another AWV in the table. When the beam direction corresponds to the AWV on the edge of the table, the table needs to be updated in order to anticipate soon pointing to a direction outside of the original FOV.

The invention is to incrementally update the LAT to drive the invoked AWV into the center of the table when the invoked AWV moves (one step or several steps). The problem is that we don't want to update the entire table in a very short time which could cause the beam movement to stop (before LAT is updated) and go (after LAT is updated). So, the method enables a more desirable incremental update.

An illustrative embodiment is provided to aid in apprehension:

In one embodiment a Look Ahead Table (LAT) is 16.times.16 array of locally accessible storage locations. The positions within LAT is (0,0) to (15,15) which corresponds to beam directions (Delta_X0, Delta_Y0), to (Delta_X0+15*delta, Delta_Y0+15*delta). Keep a point which indicates the invoked AWV in the LAT. Say, the pointer starts at (8,8) position in the 16.times.16 LAT corresponding to (Delta_X0+8*delta, Delta_Y0+8*delta) direction. When the beam direction moves to (8,7) position, we want to replace the (0,15), (1,15), . . . (15,15) AWVs with the new AWVs which corresponds to (Delta_X0, Delta_Y0−delta), (Delta_X0+delta, Delta_Y0−delta), . . . , (Delta_X0+15*delta, Delta_Y0−delta). This way, the LAT always maintain a LAT which contains −8*delta to +7delta directions from the pointer direction.

The beneficial advantage of the claimed subject matter reduces the amount of AWV updates to one row or one column at a time in lieu of writing an entire table. It also only updates the AWVs farthest away from the current direction. So, it does not cause beam movement to stop and go (waiting for LUT updates) and reduces the speed required for an update.

A computer-readable random access memory (RAM) device contains a table of antenna weights, each of which may be accessed quickly for dynamic beam forming.

An efficient method for requesting, receiving, and downloading externally stored antenna weights when necessary overwrites a row or a column in the RAM.

A circuit tracks the changing orientation of the beam within a much larger virtual array of antenna weights to determine a delta azimuth or delta elevation and its rate of change.

If the rate of angular antenna direction change exceeds a threshold, a row or column of the RAM may be determined to be least likely to be read next and is overwritten with antenna weights more likely to be read next.

An address translation circuit represents the RAM as a barrel whose recently overwritten row or column effectively repositions the latest orientation of the beam at the center of the antenna weight table.

An external non-transitory data storage device is coupled to an array of antenna control integrated circuits by a bus. The external non-transitory data storage device receives a command to update the antenna control integrated circuit with a row of antenna weights or a column of antenna weights or both.

A row or a column of antenna weights is transmitted to and received by a plurality of antenna control circuits.

Each antenna control circuit receives the antenna weights and stores into row or column of a random access computer-readable memory providing an antenna weight look ahead table (LAT) and receives and stores a virtual memory row or column address for the received antenna weights.

A field of view autopilot circuit receives a beam direction coordinate and upon applying a threshold, transmits a LAT virtual memory row or column address to each antenna control circuit and to the external non-transitory data storage device.

A field of view autopilot circuit stores four corners of a virtual Look up table which identify the least row, least column, greatest row, and greatest column indices. In addition, the field of view autopilot circuit stores one or more margin values (MV). In one embodiment, these define a rectangular annulus of the LAT: least row index plus MV, least column index plus MV, greatest row index minus MV, and greatest column index minus MV.

When the field of view autopilot circuit receives a beam direction coordinate which is interior to the annulus, no action is required. When the field of view (FoV) autopilot receives a beam direction in any of the rows or columns of the annulus, it requests antenna weights from the external non-transitory data storage device. At least one row or column of antenna weights are requested to place the most recent beam direction coordinate within the interior of the rectangular annulus, i.e. the hole of the donut.

Another way to describe the transformation of the beam direction coordinate is to translate the four corners of the LAT left or right, up or down, higher or lower, more inside or more outside, north or south, east or west, or in an embodiment diagonally NW, NE, SW, or SE.

In an embodiment, a beam direction coordinate at the corners of the annulus or adjacent to the corners of the annulus would initiate a row request followed by a column request or vice versa.

In an embodiment the annulus may be divided into a portion that requests two rows or columns and a portion that requests one row or column, and a portion that requests one row and one column.

Another embodiment with 9 zones is disclosed:

We define an antenna weight vector (AWV) bullseye Look Ahead Table (LAT) with 9 blocks of various sizes. The center block is termed the AWV Pupil. Surrounding the AWV Pupil are eight AWR Iris blocks: N, S, E, W and NE, SE, SW, NW. When a Tracker circuit determines that the Antenna Beam Focus (ABF) has entered one of the AWR Iris blocks, one or more Antenna Weight Vectors are requested. Note that once one or more antenna weight vectors are requested and received, the borders of the pupil and iris blocks are updated.

Each block of the LAT is a rectangular array of table elements each containing an AWV.

Applicant defines a Cylinder Seam and a Barrel Seam which intersect at a corner of the LAT. By incrementing or decrementing the Cylinder Seam, a column of the AWV store is reassigned from one edge of the LAT to the opposite edge. By incrementing or decrementing the Barrel Seam, a row of the AWV store is reassigned from one horizontal edge of the LAT to the opposite horizontal edge. The column or row reassigned is overwritten with AWV data read from external non-transitory storage. The boundaries of the Iris and pupil are also changed by incrementing or decrementing the Cylinder Seam and the Barrel Seam. The tracker circuit continuously determines which of the 9 blocks contains the Antenna Beam Focus.

Tracking the Antenna Beam Focus (ABF), reading Antenna Weight Vectors from every location

Increment the Barrel Seam once and the Cylinder Seam once when the ABF is in NE block

Increment the Cylinder Seam twice when the ABF is in the outer E block,

Increment the Cylinder Seam once when the ABF is in the inner E block

Increment the Barrel Seam twice when the ABF is in the outer N block

Increment the Barrel Seam once when the ABF is in the inner N block;

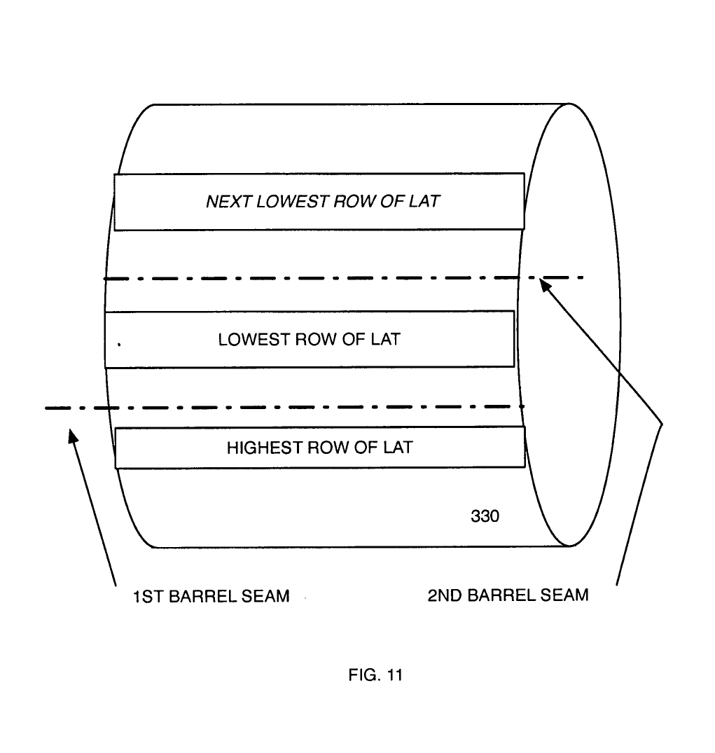

Note that the Barrel Seam denotes where the LAT is unrolled so that the Lowest Row is adjacent to the Highest Row. See FIG. 11.

By incrementing the Barrel Seam, it moves from the position of the 1st BARREL SEAM to the position of the 2ND BARREL SEAM.

Upon incrementing, the NEXT LOWEST ROW OF LAT becomes the new LOWEST ROW OF LUT as it is next to the 2ND BARREL SEAM.

The storage location of the former LOWEST ROW OF LAT must be overwritten with new Antenna Weight Vectors (AWV) appropriate to its new role as the HIGHEST ROW OF LUT.

Each block boundary is recalcuated based on the 2nd BARREL SEAM and/or 2nd Cylinder Seam. Tracking continues for the ABF.

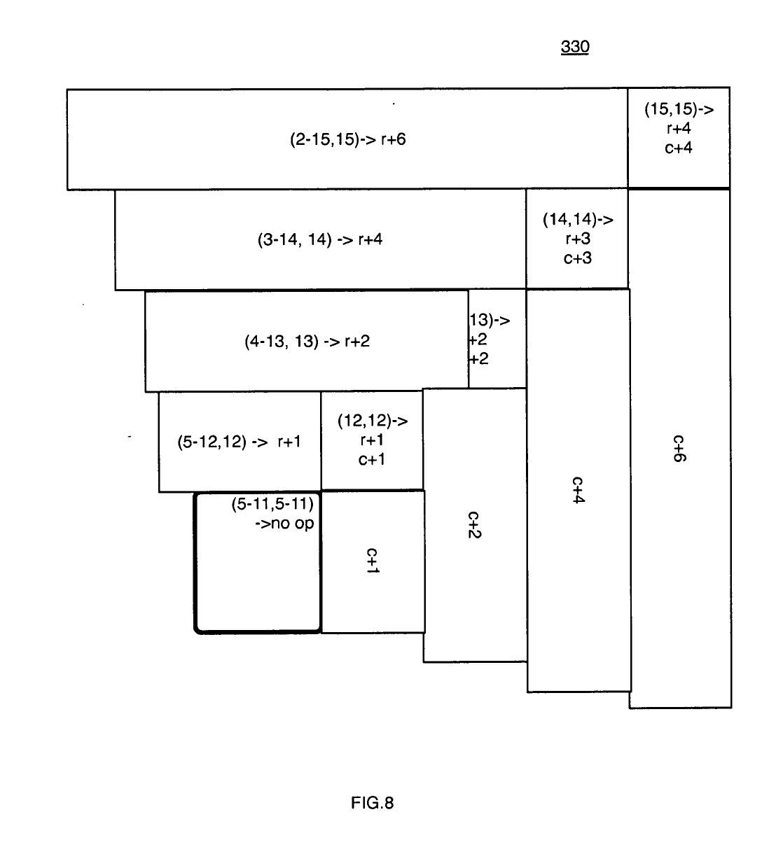

FIG. 8 is an illustration of one corner of an embodiment of the method which handles a widely varying beam direction such as when a direction may move two or more increments of angle at a time. Here we may be ready to request 2-6 rows and or columns of AWV data at a time unless the beam is stable within a square defined in this example by the corners (5,5) and (11,11).

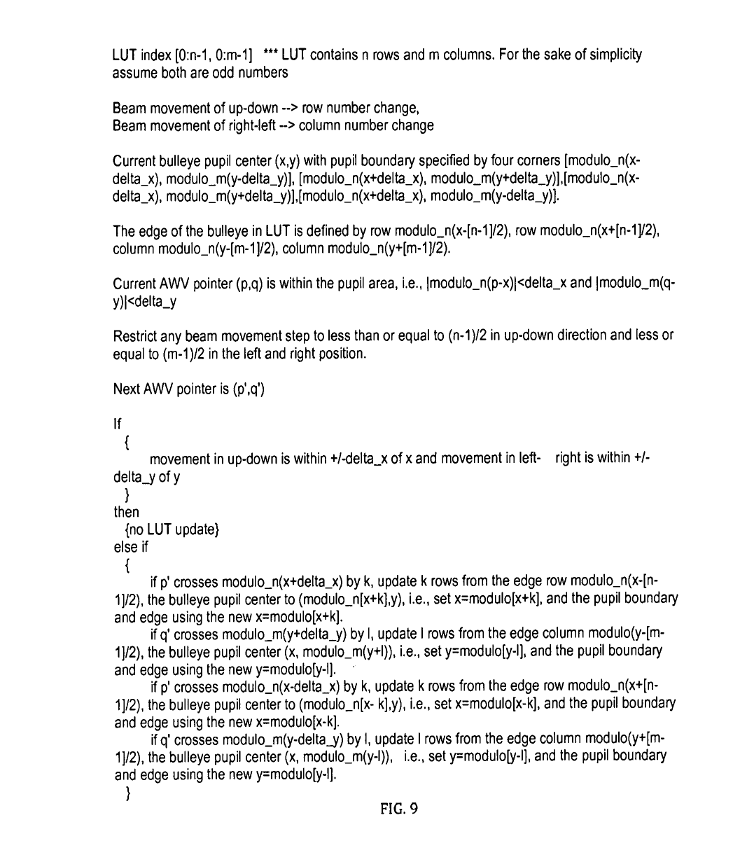

In another exemplary embodiment, a processor performs a method to control storage devices coupled by a bus to antenna array devices by FIG. 9 instructions encoded on non-transitory media:

A method for transforming a Look Ahead Table (LAT):

LAT index [0:n−1, 0:m−1] *** LAT contains n rows and m columns. For the sake
of simplicity of exposition, assume both are odd numbers, without limiting the
generality of the disclosure: Beam movement of up−down−>row number
change, Beam movement of right−left−>column number change Current bulleye
pupil center (x,y) with pupil boundary specified by four corners [modulo_n(x−
delta_x), modulo_m(y−delta_y)], [modulo_n(x+delta_x), modulo_m(y+delta_y)],
[modulo_n(x−delta_x), modulo_m(y+delta_y)], [modulo_n(x+delta_x),
modulo_m(y−delta_y)]. The edge of the bulleye in LAT is defined by row
modulo_n(x−[n−1]/2), row modulo_n(x+[n−1]/2), column modulo_n(y−[m−1]/ 2),
column modulo_n(y+[m−1]/ 2). Current AWV pointer (p,q) is within the pupil
area, i.e., |modulo_n(p−x)|<delta_x and |modulo_m(q−y)|<delta_y Restrict any
beam movement step to less than or equal to (n−1)/2 in up−down direction and
less or equal to (m−1)/2 in the left and right position. Next AWV pointer is
(p′,q′)

TABLE US-00001

If { movement in up−down is within +/−delta_x of x and
movement in left− right is within +/−delta_y of y } then {no LAT update} else if {
if p′ crosses modulo_n(x+delta_x) by k, update k rows from the edge row
modulo_n(x−[n−1]/2), the bulleye pupil center to (modulo_n[x+k],y), i.e., set
x=modulo[x+k], and the pupil boundary and edge using the new
x=modulo[x+k]. if q′ crosses modulo_m(y+delta_y) by 1, update 1 rows from
the edge column modulo(y−[m−1]/2), the bulleye pupil center (x,
modulo_m(y+1)), i.e., set y=modulo[y−1], and the pupil boundary and edge
using the new y=modulo[y− 1]. if p′ crosses modulo_n(x−delta_x) by k, update k
rows from the edge row modulo_n(x+[n−1]/2), the bulleye pupil center to
(modulo_n[x− k],y), i.e., set x=modulo[x− k], and the pupil boundary and edge
using the new x=modulo[x−k]. if q′ crosses modulo_m(y−delta_y) by 1, update
1 rows from the edge column modulo(y+[m−1]/ 2), the bulleye pupil center (x,
modulo_m(y−1)), i.e., set y=modulo[y−1], and the pupil boundary and edge
using the new y=modulo[y− 1]. }

When the Beam Focus is within the bullseye pupil, the AWV is elaborated from received signal characteristics.

Another preferred embodiment is to receive a signal using a plurality of AWVs (typically orthogonal sets) and measure the receive phase and magnitude corresponding to each AWV. The resultant measured set of phase and magnitude can be used to solve for the AWV which can optimize for the received power. For a transmit array, a preferred embodiment is to adaptively adjust the transmit AWV while obtaining the feedback of the remote receiver. Again, a pre-determined set of process steps can be used to search the AWVs for the peak of the received power. In an embodiment, this is done through gradient search.

Another preferred embodiment of a method to calibrate the transmit array is to transmit through a set of fixed set of nonsingular set of AWVs (typically orthogonal sets) and measure the receive phase and magnitude at the remote receiver and feedback to measured results to the transmit array to solve for the AWV which optimize the receive power.

Another preferred embodiment is to pre-calibrate the transmit AWV with each corresponding receive AWV pointing to the same direction. Whenever a receive AWV is in use as a result of receive antenna tracking, the corresponding transmit AWV is also used for transmitting signal.

An apparatus is configured to efficiently elaborate phase shift weights into a submodule of a phased-array antenna system. Each subarray phase control submodule is uniquely configured to receive and elaborate weights for a submodule of elements to control phase shifters. Major operators and minor operators are received and transformed by an apparatus coupled to a phased-array antenna suitable for a high mobility device. Each submodule determines its own base phase shift weight per its unique configuration. A recursive adder or multiplier applies phase increments to direct an antenna beam by controlling elements within an array subset.

Another distinguishing aspect of the invention is a computer-readable random access memory (RAM) device contains a table of antenna weights, each of which may be accessed quickly for dynamic beam forming.

A circuit tracks the changing orientation of the beam within a much larger virtual array of antenna weights to determine a delta azimuth or delta elevation and its rate of change.

If the rate of change exceeds a threshold, a row or column of the RAM may be determined to be least likely to be read next and is overwritten with antenna weights more likely to be read next.

One aspect of the invention is a method performed by a processor to control retrieval and storage of AWVs into a spherical look ahead table for a phased-array antenna beam direction control circuit reading at least one antenna weight vector (AWV) from a location in a look ahead table (LAT); determining from signal strengths and phases a desired beam pointing direction; determining that the desired beam pointing direction has transited into a first annular location in the LAT; determining which at least one boundary of the LAT is farther from the desired beam pointing direction; reading at least one of a row of AWV and a column of AWV from external non-transitory store; writing over at least one of a row of AWV and a column of AWR of the LAT at boundary farthest from the desired beam pointing; and repositioning at least one of a column seam and a row seam, whereby at least one boundary of the LAT is shifted outward away from the desired beam pointing direction which had transited into the first annular location of the LAT.

The method includes correlating the individual element output signal with the combined signal output to optimize the AWV which provides the optimized correlated output power. Embodiments include closed loop or open loop operation. Another preferred embodiment is to receive a signal using a set of nonsingular set of AWVs (typically orthogonal sets) and measure the receive phase and magnitude corresponding to each AWV. These resultant measured set of phase and magnitude are transformed to solve for the AWV which optimize for the received power. For transmit array, a preferred embodiment is to adaptively adjust the transmit AWV while obtain the feedback of the remote receiver. The method also includes a pre-determined set of transformations to search the AWVs for the peak of the received power (done through gradient search).

Another preferred embodiment to calibrate the transmit array is to transmit through a set of fixed set of nonsingular set of AWVs (typically orthogonal sets) and measure the receive phase and magnitude at the remove receiver and feedback to measured results to the transmit array to solve for the AWV which optimized the receive power. In some array, the receive element and the transmit element are collocated or placed in proximity, to compensate the dimension error in the transmit array, the same compensation for receive array can be used for transmit array since it is expected that the dimension error will be approximately the same value.

In an embodiment, the apparatus performs a Type III steering method when a remote transceiver is near the horizon of the antenna or approaching the horizon beyond a threshold rate of change, a sub-set of phased-array antenna elements is assigned AWVs toward an expected or anticipated transceiver rise above the horizon of the phased-array antenna.

One embodiment would be a wrap around beam-splitting circuit which has a circuit to determine angular velocity of the antenna beam; a circuit to determine proximity of the antenna beam to a horizon of the phased-array antenna; a circuit to determine a condition that a target transceiver will set below the horizon of the phased-array antenna based on antenna beam elevation and on the angular velocity exceeding a threshold; a circuit to determine a predicted azimuth for a target transceiver rise above the horizon of the phased-array antenna based on one of expected rollover and anticipated handover; and, a circuit to distribute AWV to a subset of the phased-array antenna system to provide beam-splitting.

### CONCLUSION

The above disclosure of embodiments is illustrative of the principles of the claimed invention and does not limit the size of sub-array and the partition of the subarray within overall array.

Note that the phase shifters in the overall array do not need to exist physically. The desired phase shift applying to a subarray can be obtained via a circuit by adding a common phase-shift to all phased-shifters within the subarray. This eliminates the higher layer phase shifters in the array.

Note that method and apparatus described above is simplified for ease of apprehension and is intended to be extensible to phased-array or adaptive array antenna system with multiple layers.

The techniques described herein can be implemented in digital electronic circuitry, or in computer hardware, firmware, software, or in combinations of them. The techniques can be implemented as a computer program product, i.e., a computer program tangibly embodied e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

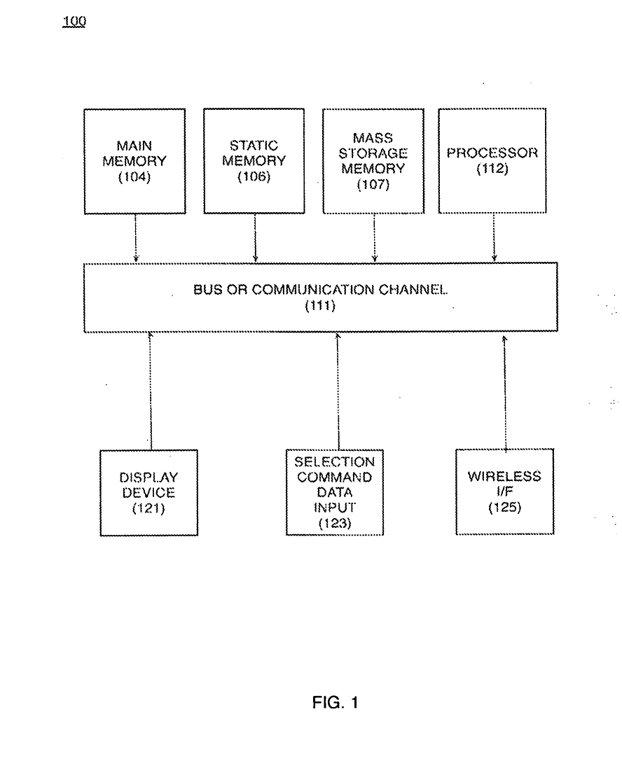

FIG. 1 is a block diagram of an exemplary processor that may be used to perform one or more of the functions described herein. Referring to FIG. 1, processor 100 may comprise an exemplary client or server process. Processor 100 comprises a communication mechanism or bus 111 for communicating information, and a processor core 112 coupled with bus 111 for processing information. Processor core 112 comprises at least one processor core, but is not limited to a processor core, such as for example, ARM™, Pentium™, etc.

Processor 100 further comprises a random access memory (RAM), or other dynamic storage device 104 (referred to as main memory) coupled to bus 111 for storing information and instructions to be executed by processor 112. Main memory 104 also may be used for storing temporary variables or other intermediate information during execution of instructions by processor core 112.

Processor 100 also comprises a read only memory (ROM) and/or other static storage device 106 coupled to bus 111 for storing static information and instructions for processor core 112, and a non-transitory data storage device 107, such as a magnetic storage device or flash memory and its associated control circuits. Data storage device 107 is coupled to bus 111 for storing information and instructions.

Processor 100 may further be coupled to a display device 121 such a flat panel display, coupled to bus 111 for displaying information to a computer user. Voice recognition, optical sensor, motion sensor, microphone, keyboard, touch screen input, and pointing devices 123 may be attached to bus 111 or a wireless network interface 125 for communicating selections and command and data input to processor core 112.

A number of embodiments of the invention have been described. Nevertheless, it will be understood that various modifications may be made without departing from the spirit and scope of the invention. For example, other network topologies may be used. Accordingly, other embodiments are within the scope of the following claims.

1. A layered phased-array antenna system comprising:
at least one antenna weight vector (AWV) determination circuit;
a serial bus to disseminate phase shift control information; and,
a layered construct of sub-arrays.

2. The layered phased-array antenna system of claim 1, wherein at least one antenna weight vector (AWV) determination circuit is an AWV elaboration circuit comprising:
a circuit to receive a major operator and a minor operator; a circuit to determine a base phase shift weight;
a circuit to apply one or more multiples of the minor operator; a circuit to measure the receive phase and magnitude;
a circuit to vary the major operator and the minor operator; and
a circuit to solve for an AWV which optimizes the receive power.

3. The layered phased-array antenna system of claim 1, wherein the layered construct of subarrays comprises:
in a first layer, a plurality of passively combined antenna elements;
in a second layer, low noise amplifiers and phase shifters for reception, and phase shifters and power amplifiers for transmission;
in a third layer, combiners for reception, and splitters for transmission, and interconnect between the phase shifters and amplifiers to the at least one antenna weight vector (AWV) determination circuit.
